(19) United States
(12) Patent Application Publication
(10) Pub. No.: US 2026/0246176 A1
(43) Pub. Date: Aug. 20, 2026

(54) CONNECTOR

(71) Applicant: DONGGUAN LEADER PRECISION INDUSTRY CO., LTD., Dongguan City (CN)

(72) Inventors: Zhongyuan LAI, Dongguan City (CN); Zhengguo SUN, Dongguan City (CN); Jinqi LI, Dongguan City (CN)

(73) Assignee: DONGGUAN LEADER PRECISION INDUSTRY CO., LTD., Dongguan City (CN)

(21) Appl. No.: 19/441,246

(22) Filed: Jan. 6, 2026

(30) Foreign Application Priority Data
Feb. 17, 2025 (CN) 202520250772.4

(51) Int. Cl. H01R 12/72; H01R 12/70; H01R 13/6585

(52) U.S. Cl. CPC H01R 12/722; H01R 12/7047; H01R 13/6585

(57) ABSTRACT

The present application relates to a connector. The connector includes a circuit board and a connection module. The circuit board is provided with a first fool-proof portion; the connection module is provided with a second fool-proof portion, and the second fool-proof portion is matched with the first fool-proof portion.

### CROSS-REFERENCE TO RELATED APPLICATION(S)

The present application claims all the benefits of Chinese Patent Application No. 202520250772.4 filed on February 17, 2025 and entitled “Connector”, which is incorporated herein by reference in its entirety.

### Field

The present application relates to the technical field of electronic communications, and in particular, to a connector.

### Background

In a connector, a plurality of signal terminals are often correspondingly connected to a plurality of metal contacts of an internal circuit board to implement data transmission and signal exchange between an external device and the internal circuit board.

When a connection module with the plurality of signal terminals is assembled with the circuit board, tail ends of the signal terminals are often electrically connected to corresponding pads or insertion holes on the circuit board by welding, insertion, etc. However, when the signal terminals are assembled with the circuit board by welding, the heating temperature and time in the welding process need to be strictly controlled, otherwise the signal terminals and the circuit board may be damaged; and when the signal terminals are assembled with the circuit board by insertion, a plurality of slots need to be pre-prepared on the circuit board, making the manufacturing process complex.

The related art proposed an assembly method, in which the tail ends of the signal terminals are designed to be elastic, and then abut against the corresponding metal contacts of the circuit board through the elasticity to achieve electrical connection. However, this assembly method requires dense arrangement of a plurality of metal fingers or other metal contacts on a side of the circuit board, wherein the side faces the connection module.

### SUMMARY

An embodiment of the present application provides a connector, including: a circuit board, wherein the circuit board is provided with a first fool-proof portion; and a connection module, wherein the connection module is provided with a second fool-proof portion, and the second fool-proof portion is matched with the first fool-proof portion.

### BRIEF DESCRIPTION OF THE DRAWINGS

FIG. 1 is a first schematic structural diagram of a connector according to an embodiment of the present application;

FIG. 2 is an exploded view of a connector according to an embodiment of the present application;

FIG. 3 is a schematic structural diagram of a circuit board according to an embodiment of the present application;

FIG. 4 is a schematic structural diagram of a connection module according to an embodiment of the present application;

FIG. 5 is an enlarged detail view of part A in FIG. 1 according to an embodiment of the present application;

FIG. 6 is a second schematic structural diagram of a connector according to an embodiment of the present application;

FIG. 7 is a first partial cross-sectional view of a connector according to an embodiment of the present application;

FIG. 8 is an enlarged detail view of part B in FIG. 7 according to an embodiment of the present application;

FIG. 9 is a schematic structural diagram of a signal terminal according to an embodiment of the present application;

FIG. 10 is a first partial structural diagram of a connection module according to an embodiment of the present application;

FIG. 11 is a second partial structural diagram of a connection module according to an embodiment of the present application;

FIG. 12 is a third partial structural diagram of a connection module according to an embodiment of the present application;

FIG. 13 is a cross-sectional view of FIG. 11 according to an embodiment of the present application;

FIG. 14 is a second partial cross-sectional view of a connector according to an embodiment of the present application; and

FIG. 15 is a schematic structural diagram of a first shielding member according to an embodiment of the present application.

### DETAILED DESCRIPTION

In order to make the objectives, technical solutions, and advantages of the embodiments of the present application clearer, the technical solutions in the embodiments of the present application will be described clearly and completely below in conjunction with the accompanying drawings therein. Apparently, the described embodiments are some of the embodiments of the present application, not all of them. Based on the embodiments of the present application, all other embodiments obtained by those of ordinary skill in the art without any creative effort shall fall within the scope of protection of the present application.

The following disclosure provides many different embodiments or examples to implement different structures of the present application. In order to simplify the disclosure of the present application, components and settings in specific examples are described below. Such components and settings are merely examples and are not intended to limit the scope of the present application. In addition, the present application may repeat reference numerals and/or letters in different examples. The repetition is for the purpose of simplification and clarity, and does not indicate the relationship between various discussed embodiments and/or settings.

For ease of description, spatial relative relationship terms can be used herein to describe the relative position or motion of one element or feature shown in the figures relative to the other element or feature. These relative relationship terms include "internal", "external", "inner", "outer", "below", "under", "on", "above", "front", "rear", etc. The spatial relative relationship terms are intended to include different orientations of an apparatus in use or operation, in addition to the orientations depicted in the figures. For example, if the apparatus in the figures undergoes a position flip, posture change, or motion state change, these directional indications also change accordingly. For example, one element described as "below the other element or feature" or "under the other element or feature" will subsequently be oriented as "on the other element or feature" or "above the other element or feature". Therefore, the exemplary term "under" may include both upper and lower orientations. The apparatus can be oriented otherwise (rotated 90 degrees or in other directions) and the spatial relative relationship descriptors used herein are explained accordingly.

In order to solve the technical problem in the related art that connectors cannot be used normally due to the fact that the connection of a plurality of signal terminals 3 to a plurality of metal contacts 12 on a circuit board 1 is prone to misalignment, the present application provides a connector, wherein the circuit board 1 is provided with a first fool-proof portion 11, and a connection module is provided with a second fool-proof portion 21. By matching the first fool-proof portion 11 with the second fool-proof portion 21, assembly positioning between the circuit board 1 and the connection module is achieved, so that the plurality of metal contacts 12 on the circuit board 1 can be accurately positioned with the plurality of signal terminals 3 in the connection module, thereby achieving accurate corresponding connections between the plurality of signal terminals 3 and the plurality of metal contacts 12, ensuring stable and accurate signal transmission of the connector, and avoiding signal attenuation or interruption caused by poor connection.

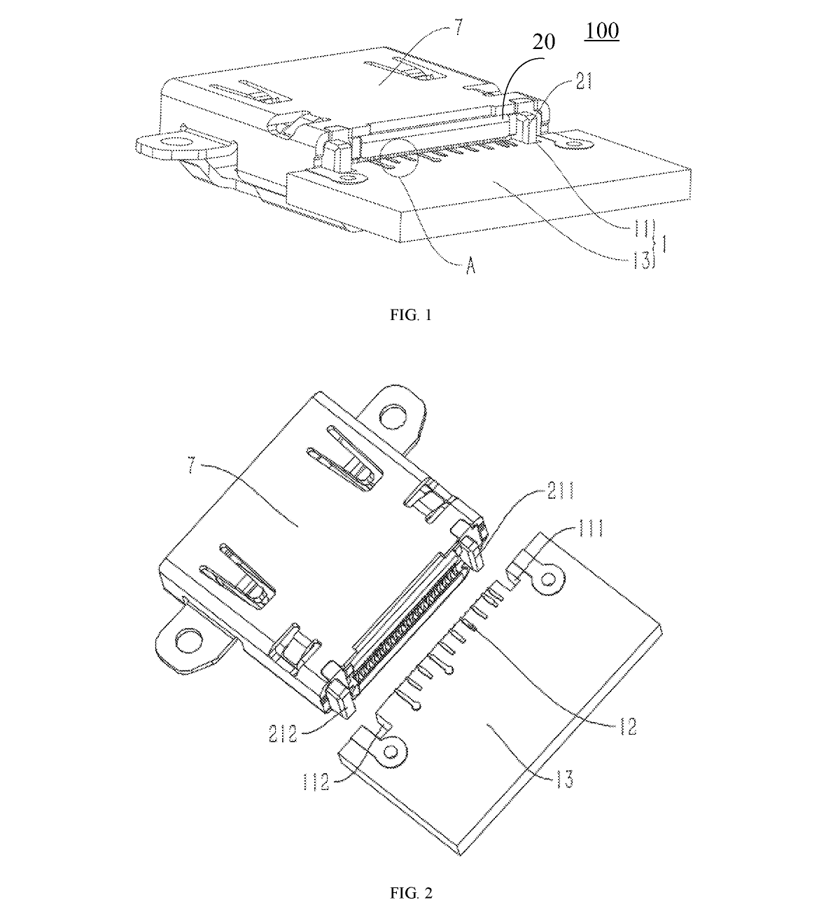

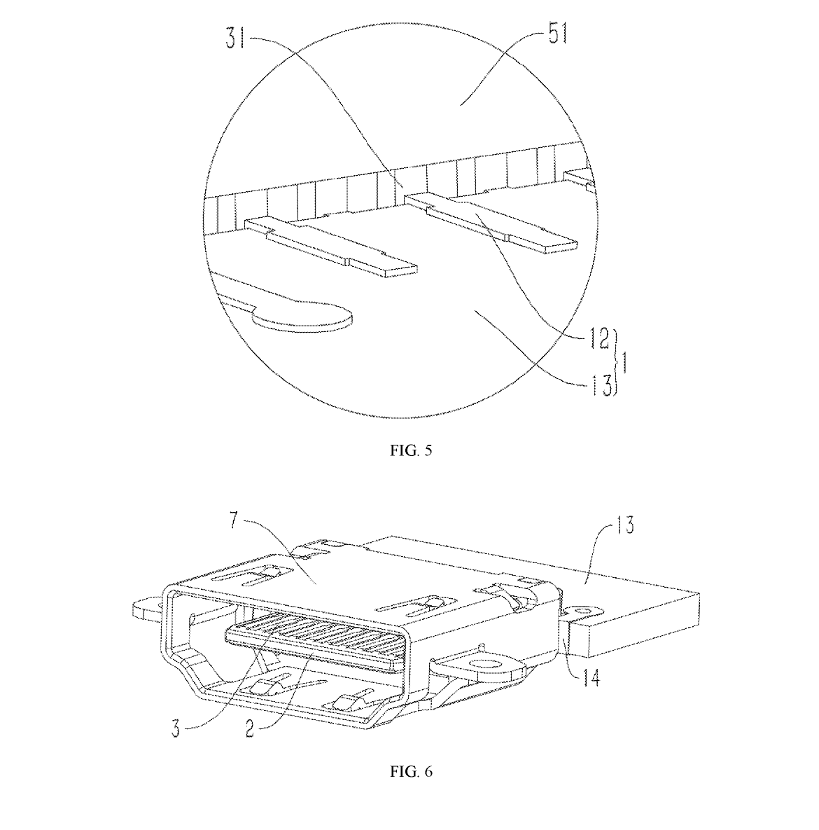

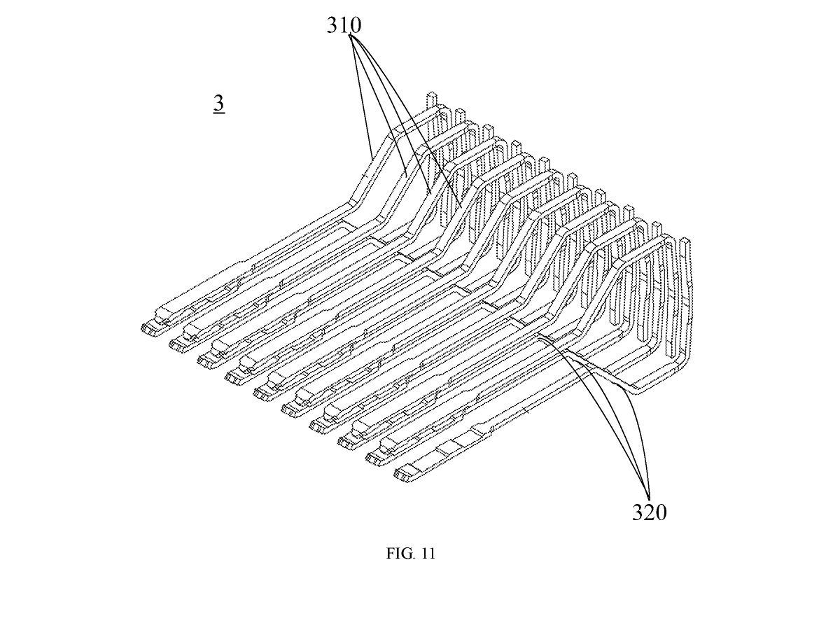

With reference to FIG. 1 to FIG. 15, an embodiment of the present application provides a connector 100, including a circuit board 1 and a connection module 20, wherein the circuit board 1 is provided with a first fool-proof portion 11, the connection module 20 is provided with a second fool-proof portion 21, and the second fool-proof portion 21 is matched with the first fool-proof portion 11. By matching the first fool- proof portion 11 with the second fool-proof portion 21, fool-proof and error-proof assembly can be achieved when the connection module is docked with the circuit board 1, so that the plurality of signal terminals 3 in the connection module are correctly docked with and abut against the plurality of metal contacts 12 on the circuit board 1, as shown in FIG. 1 and FIG. 5.

It should be noted that the accurate connection between the signal terminals 3 in the connector and the metal contacts 12 in the circuit board 1 plays a key role in ensuring the stability and integrity of signal transmission in the connector and improving the reliability of the connector, thereby avoiding signal attenuation or interruption caused by poor connection, and making the connector suitable for scenarios wherein the signal terminals 3 are assembled with the circuit board 1 through crimping.

In some embodiments of the present application, as shown in FIG. 1 and FIG. 2, the first fool-proof portion 11 is arranged at an end, facing the connection module, of the circuit board 1, and the second fool-proof portion 21 is arranged at an end, facing the circuit board 1, of the connection module. When the connection module is docked with the circuit board 1, docking guidance and assembly positioning between connection modules can be achieved by matching the first fool-proof portion 11 with the second fool-proof portion 21.

As a specific embodiment of the present application, a front end of the connection module is used for insertion into other electronic devices, a rear end of the connection module is used for docking with the circuit board 1, the second fool-proof portion 21 is arranged at the rear end of the connection module, and the first fool-proof portion 11 is arranged at a front end of the circuit board 1, as shown in FIG. 2.

In some embodiments of the present application, as shown in FIG. 1 to FIG. 4, the first fool-proof portion 11 and the second fool-proof portion 21 are in concave-convex fit. One of the fool-proof portions may be directly embedded into the other one to achieve assembly positioning between the connection module and the circuit board 1, so that the assembly process is convenient and highly accurate, and the assembly efficiency between the connection module and the circuit board 1 can be improved.

It should be noted that the first fool-proof portion 11 and the second fool-proof portion 21 can achieve fool-proof and error-proof assembly between the connection module and the circuit board 1 through one or more concave-convex fit areas. As long as the concave-convex fit areas of the first fool-proof portion 11 and the second fool-proof portion 21 do not affect the docking between the signal terminals 3 and the metal contacts 12, the objective of the present application can be achieved.

In some embodiments of the present application, the first fool-proof portion 11 and the second fool-proof portion 21 achieve fool-proof and error-proof assembly between the connection module and the circuit board 1 through a single concave-convex fit area. Preferably, the first fool-proof portion 11 is arranged on a side of the front end of the circuit board 1, and the second fool-proof portion 21 is arranged a side, corresponding to the first fool-proof portion 11, of the rear end of the connection module, so that the concave-convex fit between the first fool-proof portion 11 and the second fool-proof portion 21 can be achieved only when the circuit board 1 is correctly placed. If the circuit board 1 is turned over, the first fool-proof portion 11 and the second fool-proof portion 21 are located on left and right sides of the circuit board 1 respectively, and assembly personnel can then quickly detect assembly errors.

In other embodiments of the present application, as shown in FIG. 1 to FIG. 4, the first fool-proof portion 11 includes a first fool-proof groove 111 and a second fool-proof groove 112, the second fool-proof portion 21 includes a first fool-proof block 211 and a second fool-proof block 212, the first fool-proof groove 111 is matched with the first fool-proof block 211, and the second fool-proof groove 112 is matched with the second fool-proof block 212. When the first fool-proof block 211 is embedded in the first fool-proof groove 111 and the second fool-proof block 212 is embedded in the second fool-proof groove 112, accurate docking between the connection module and the circuit board 1 can be achieved.

It should be noted that the cross-sectional shapes of the first fool-proof groove 111 and the second fool-proof groove 112 may be rectangular, semi-circular, polygonal, etc. When the cross-sectional shapes of the first fool-proof groove 111 and the second fool-proof groove 112 are different, the first fool-proof block 211 matched with the first fool-proof groove 111 can only achieve concave-convex fit with the first fool-proof groove 111, while the second fool-proof block 212 matched the second fool-proof groove 112 can only achieve concave-convex fit with the second fool-proof groove 112. When the cross-sectional shapes of the first fool-proof groove 111 and the second fool-proof groove 112 are the same (such as the both are rectangular or semi-circular), the cross-sectional dimensions of the first fool-proof groove 111 and the second fool-proof groove 112 are different (the cross-sectional dimensions may be width, length, diameter, etc.). Through dimensionally differential design, the first fool-proof groove 111 can only achieve concave-convex fit with the first fool-proof block 211, and the second fool-proof groove 112 can only achieve concave-convex fit with the second fool-proof block 212.

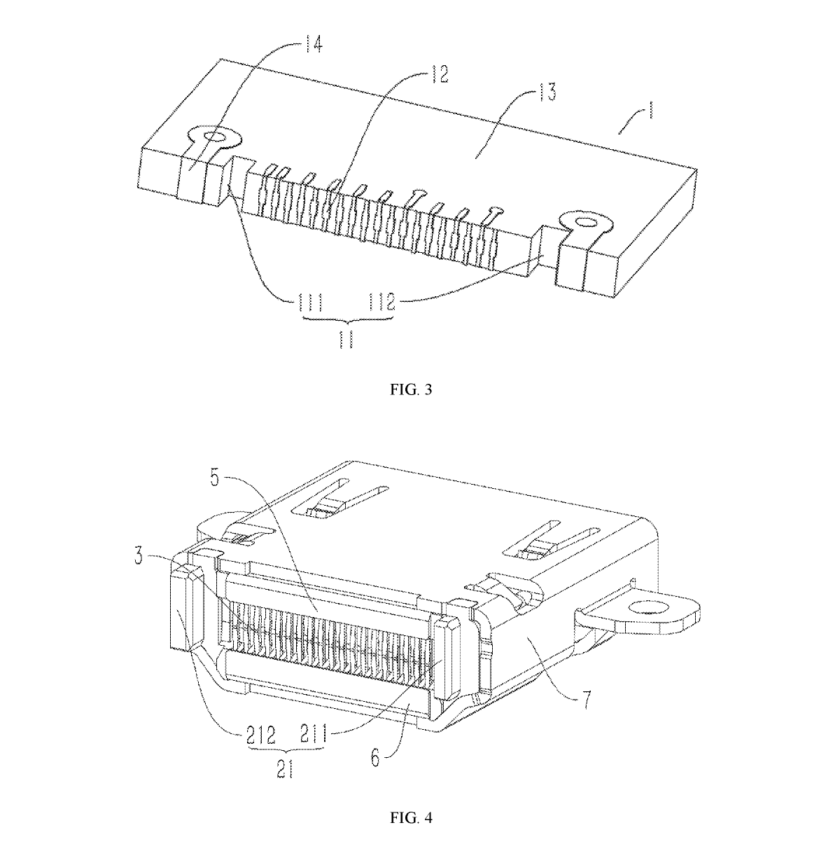

In some embodiments of the present application, as shown in FIG. 2 and FIG. 3, the cross-sectional shapes of the first fool-proof groove 111 and the second fool-proof groove 112 are the same, and the dimension of the first fool-proof groove 111 is less than that of the second fool-proof groove 112, so that the second fool-proof block 212 cannot be embedded in the first fool-proof groove 111, thereby achieving corresponding cooperation between the first fool-proof groove 111 and the first fool-proof block 211, and between the second fool-proof groove 112 and the second fool-proof block 212.

As a specific embodiment of the present application, as shown in FIG. 2 and FIG. 3, the first fool-proof groove 111 and the second fool-proof groove 112 are two open grooves arranged at one end of a substrate 13 of the circuit board 1, the cross-sectional shapes of the first fool-proof groove 111 and the second fool-proof groove 112 in a horizontal plane are rectangular, but the cross-sectional width of the first fool-proof groove 111 is less than that of the second fool-proof groove 112, and/or the cross-sectional length of the first fool-proof groove 111 is less than that of the second fool-proof groove 112. The dimensionally differential design can achieve the objective of the present application.

In some embodiments of the present application, as shown in FIGS. 1, 3, 4, and 5, the circuit board 1 is provided with a plurality of metal contacts 12, the connection module includes a plurality of signal terminals 3, and the plurality of metal contacts 12 correspond one to one with the plurality of signal terminals 3, thereby ensuring stable and reliable electrical connections between the circuit board 1 and other electronic devices or modules through the signal terminals 3, reducing signal attenuation and interference during transmission, improving the quality of signal transmission, and facilitating high-frequency, high-speed, and high-precision signal transmission.

In some embodiments of the present application, as shown in FIG. 3, the first fool-proof portion 11 and the plurality of metal contacts 12 are arranged on a side edge of the circuit board 1, wherein the side edge faces the connection module. When the first fool-proof portion 11 is docked with the second fool-proof portion 21, the metal contacts 12 on the same side as the first fool-proof portion 11 may be synchronously aligned with the plurality of signal terminals 3 in the connection module. After the first fool-proof portion 11 is completely matched with the second fool-proof portion 21, the tail ends of the plurality of signal terminals 3 abut or press against the plurality of metal contacts 12 of the circuit board 1.

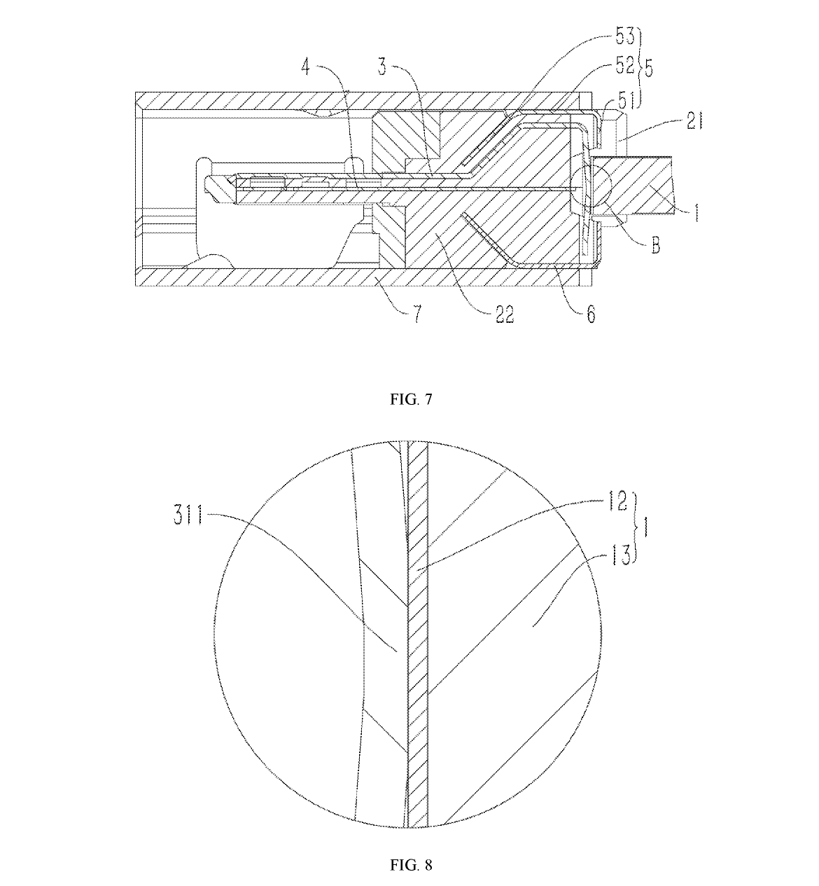

In some embodiments of the present application, as shown in FIGS. 7, 8, and 9, the signal terminal 3 includes a bent segment 31, and the bent segment 31 has a protruding portion 311 facing the metal contact 12. When the protruding portion 311 of the bent segment 31 abuts against the metal contact 12 of the circuit board 1, the elastic force of the bent segment 31 allows the protruding portion 311 to tightly abut against the metal contact 12, thereby achieving adaptive elastic contact, avoiding separation between the tail end of the signal terminal 3 and the metal contact 12, avoiding connection failure between the signal terminal 3 and the circuit board 1, and ensuring normal conduction connection of electrical transmission and signal channels.

In some embodiments of the present application, as shown in FIGS. 10 to 13, the plurality of signal terminals 3 include a plurality of first terminals 310 and a plurality of second terminals 320, and the bent segments 31 of the first terminals and the bent segments 31 of the second terminals have the same structure and opposite orientations to enclose an anti-crosstalk space 33 between the plurality of signal terminals 3, thereby increasing the spacing between the two rows of opposite signal terminals 3 and reducing crosstalk between the adjacent signal terminals 3.

It should be noted that the anti-crosstalk space 33 can reduce the coupling capacitance and mutual inductance effect between the adjacent first terminal and second terminal, thereby reducing the occurrence of crosstalk, ensuring that signals are not interfered with during transmission, improving the communication quality of the connector, and making the connector more suitable for high-precision, high-reliability, and high-frequency transmission application scenarios.

In some embodiments of the present application, as shown in FIGS. 10 to 13, the first terminals and the second terminals have the same structure, the first terminals are arranged above the second terminals, the tail ends of the first terminals and the tail ends of the second terminals are the bent segments 31, and the bending shape and size of the bent segments 31 may be designed according to the size requirements of the anti-crosstalk space 33.

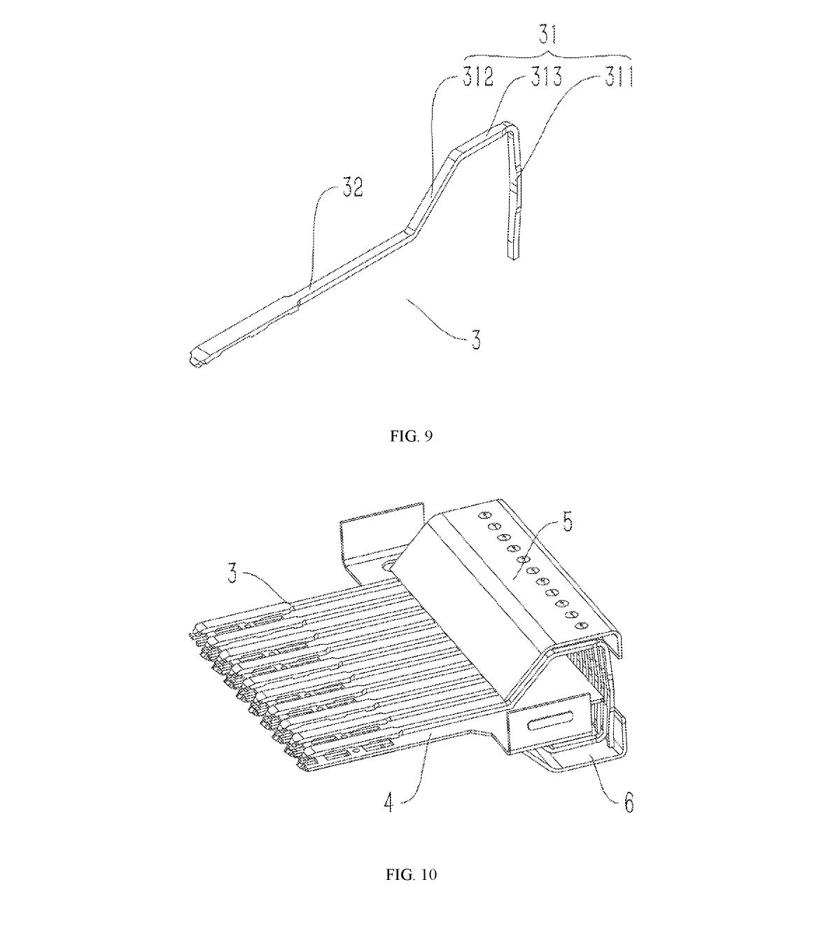

In some embodiments of the present application, as shown in FIG. 9, the signal terminal 3 includes a straight segment 32 and a bent segment 31, and the bent segment 31 includes an inclined segment 312, a horizontal segment 313, and a vertically extending protruding portion 311 connected in sequence, so that the anti-crosstalk space 33 is a pointed shuttle-shaped space, and the cross-section of the pointed shuttle-shaped space is approximately pentagonal. By adjusting the size of the pointed shuttle-shaped space, the impedance of the signal terminal 3 can be adjusted to be approximately consistent, and the impedance topology is substantially balanced, thereby reducing signal attenuation in the signal terminal 3.

In some embodiments of the present application, as shown in FIG. 7 and FIGS. 10 to 15, the connection module further includes a first shielding member 4, the plurality of signal terminals 3 are arranged on both sides of the first shielding member 4, and a portion of the first shielding member 4 extends into the anti-crosstalk space 33 to shield crosstalk electromagnetic waves between the first terminals and the second terminals and absorb crosstalk electromagnetic waves inside the anti-crosstalk space 33, thereby ensuring fast, smooth, and balanced signal transmission.

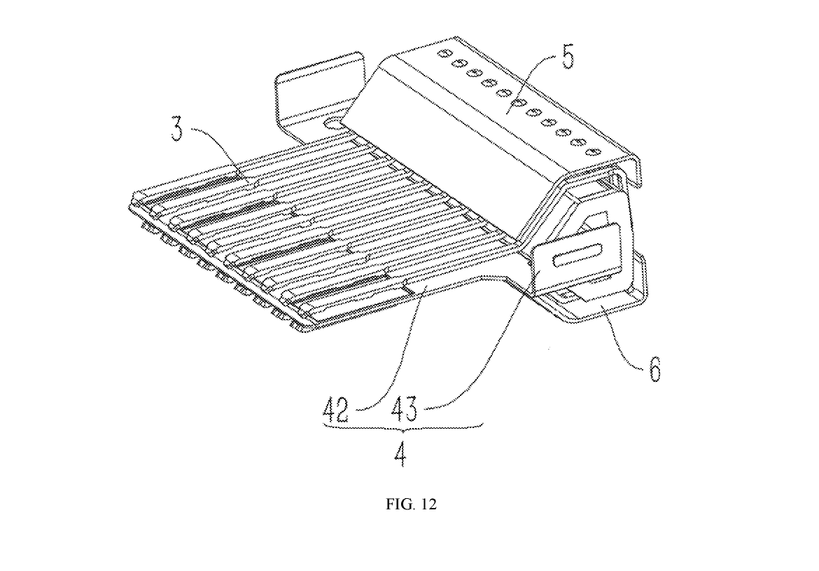

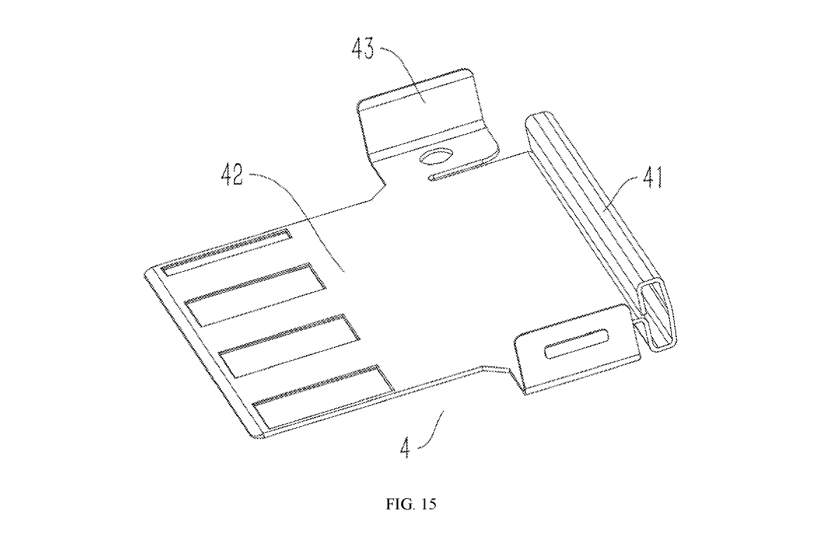

In some embodiments of the present application, as shown in FIG. 12 and FIG. 15, the first shielding member 4 includes a plate portion 42 and a tubular portion 41, wherein the plate portion 42 corresponds to the straight segment 32 of the signal terminal 3, and the tubular portion 41 corresponds to the bent segment 31 of the signal terminal 3, so that the distance between the metal plate of the tubular portion 41 and the bent segment 31 is shortened, which can improve the absorption effect of the crosstalk electromagnetic waves inside the anti-crosstalk space 33 by the tail end of the first shielding member 4.

It should be noted that the cross-sectional shape and size of the tubular portion 41 may be designed according to the requirements of impedance matching. The cross-sectional shape of the tubular portion 41 may be polygonal, circular, elliptical, etc. The tubular portion 41 may be embedded in an insulating tube 23 of an insulating body 2. As long as the crosstalk electromagnetic waves inside the anti-crosstalk space 33 can be absorbed, the objective of the present application can be achieved.

In some embodiments of the present application, as shown in FIGS. 10, 12, and 15, the first shielding member 4 is further provided with a connecting portion 43, and the connecting portion is used to abut against the inner wall of a metal shell 7. When the first shielding member 4 is assembled with the insulating body 2, the connecting portion 43 is exposed to the insulating body 2, so as to achieve electrical connection through the abutment between the connecting portion 43 and the inner wall of the metal shell 7, thereby grounding the crosstalk electromagnetic waves. The connecting portion 43 may be designed on one side or both sides of the first shielding member 4, both of which can achieve the objective of the present application.

In some embodiments of the present application, as shown in FIGS. 7, 10, 12, 13, and 14, the connection module further includes a second shielding member 5 and a third shielding member 6, wherein the second shielding member 5 and the third shielding member 6 are arranged on two outer sides of the plurality of signal terminals 3 respectively and used for electrical connection with the metal shell 7 of the connector, so that the second shielding member 5 and the third shielding member 6 have the same potential as the metal shell 7, which can shield the crosstalk electromagnetic waves outside the anti-crosstalk space 33 and prevent the metal shell 7 from introducing external crosstalk into the signal terminals 3.

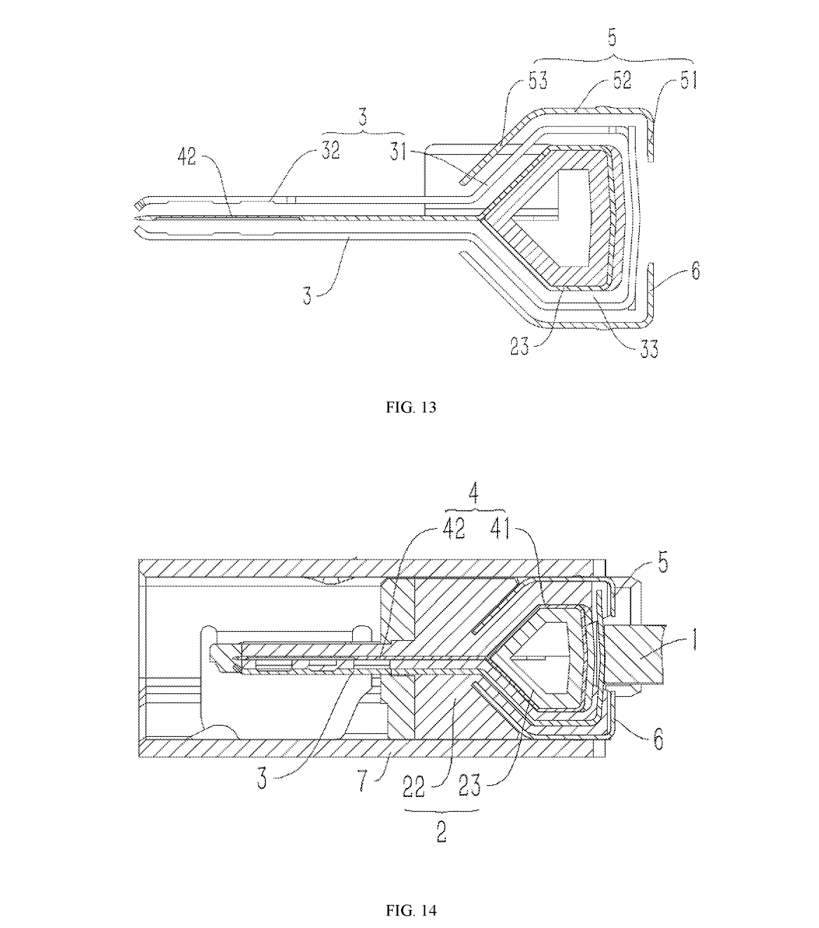

In some embodiments of the present application, as shown in FIG. 13 and FIG. 14, the shapes of the first shielding member 4, the second shielding member 5, and the third shielding member 6 are matched with the shapes of the plurality of signal terminals 3, which can maintain a suitable spacing between the signal terminals 3 and the shielding members to improve the shielding effect.

Specifically, the shape of the tubular portion 41 is matched with the shape of the anti-crosstalk space 33, so that the spacing between the outer wall of the tubular portion 41 and the plate body of the opposite bent segment 31 is identical or approximately identical. The balanced absorption of crosstalk electromagnetic waves at various positions in the circumferential direction of the bent segment 31 by the tubular portion 41 is conducive to improving the shielding effect of the tubular portion 41 on the anti-crosstalk space 33.

The second shielding member 5 and the third shielding member 6 have the same structure and opposite orientations. The second shielding member 5 includes a third plate body 53, a second plate body 52, and a first plate body 51 connected in sequence. The combination of the second shielding member 5 and the third shielding member 6 forms a pointed shuttle-shaped bidirectional signal protection structure matching the anti-crosstalk space 33, wherein the signal protection structure can avoid faults or inconsistencies in the circuit of the signal terminals 3, completely shield external crosstalk electromagnetic waves, and ensure fast, smooth, and balanced signal transmission.

In some embodiments of the present application, as shown in FIG. 7 and FIG. 14, the first shielding member 4, the second shielding member 5, the third shielding member 6, and the plurality of signal terminals 3 are all embedded in an insulating block 22 of the insulating body 2 to achieve the fixed arrangement of the first shielding member 4, the second shielding member 5, the third shielding member 6, and the plurality of signal terminals 3 in the connection module.

In some embodiments of the present application, as shown in FIG. 3 and FIG. 7, the connection module further includes an insulating body 2, and a portion of the insulating body 2 is configured as the second fool-proof portion 21, enabling the second fool-proof portion 21 to have insulation performance, which avoids unnecessary electrical connection when the second fool-proof portion 21 cooperates with the first fool-proof portion 11 on the circuit board 1.

In some embodiments of the present application, as shown in FIGS. 3, 4, and 6, the connection module further includes a metal shell 7, and the circuit board 1 is provided with a grounding contact 14 corresponding to the metal shell 7. When the connection module is docked with the circuit board 1, the metal shell 7 abuts against the grounding contact 14 on the circuit board 1 to form a grounding circuit.

With reference to FIG. 1 to FIG. 15, in some embodiments of the present application, a docking method for the foregoing connector is as follows:

Step 1: After the connection module and the circuit board 1 are produced, the first fool-proof groove 111 is aligned with the first fool-proof block 211, and the second fool-proof groove 112 is aligned with the second fool-proof block 212;

Step 2: The first fool-proof block 211 is inserted into the first fool-proof groove 111, and the second fool-proof block 212 is inserted into the fool-proof groove, allowing the plurality of signal terminals 3 to correspond to the plurality of metal contacts 12 and the metal shell to correspond to the grounding contact 14;

Step 3: The position of the circuit board 1 is adjusted, allowing the metal contact 12 to abut against the protruding portion 311 of the signal terminal 3 and the metal shell 7 to abut against the grounding contact 14 on the circuit board 1.

It should be understood that the terms used herein are only for the purpose of describing specific exemplary implementations and are not intended to be restrictive. Unless otherwise explicitly stated in the context, singular forms such as "a", "one", and "the" used herein may further include plural forms. The terms "comprise", "include", "contain", and "have" are inclusive and therefore indicate the existence of the stated features, steps, operations, elements, and/or components, but do not exclude the existence or addition of one or more other features, steps, operations, elements, components, and/or combinations thereof. The method steps, processes, and operations described herein are not interpreted as requiring them to be executed in a specific order described or illustrated, unless an execution order is clearly indicated. It should also be understood that additional or alternative steps can be used.

Although the terms first, second, third, etc. can be used herein to describe a plurality of elements, components, regions, layers, and/or segments, these elements, components, regions, layers, and/or segments should not be limited by these terms. These terms can only be used for distinguishing one element, component, region, layer, or segment from another. Unless explicitly stated in the context, the terms such as "first" and "second" and other numerical terms used herein do not imply order or sequence. Therefore, the first element, component, region, layer, or segment discussed below may be referred to as the second element, component, region, layer, or segment without departing from the teachings of the example embodiments.

Described above are merely specific implementations of the present application, enabling a person skilled in the art to understand or implement the present application. Various modifications to these embodiments are apparent to the person skilled in the art. General principles defined herein may be implemented in other embodiments without departing from the spirit or scope of the present application. Therefore, the present application will not be limited to these embodiments shown herein, but will conform to the widest scope consistent with the principle and novelty of the present application.

What is claimed is:

1. A connector, comprising:
a circuit board, wherein the circuit board is provided with a first fool-proof portion; and
a connection module, wherein the connection module is provided with a second fool-proof portion, and the second fool-proof portion is matched with the first fool-proof portion.

2. The connector according to claim 1, wherein the first fool-proof portion and the second fool-proof portion are in concave-convex fit.

3. The connector according to claim 1, wherein the first fool-proof portion comprises a first fool-proof groove and a second fool-proof groove, the second fool-proof portion comprises a first fool-proof block and a second fool-proof block, the first fool-proof groove is matched with the first fool-proof block, and the second fool-proof groove is matched with the second fool-proof block.

4. The connector according to claim 3, wherein the dimension of the first fool-proof groove is less than that of the second fool-proof groove.

5. The connector according to claim 1, wherein the circuit board is provided with a plurality of metal contacts, the connection module comprises a plurality of signal terminals, and the plurality of metal contacts correspond one to one with the plurality of signal terminals.

6. The connector according to claim 5, wherein the first fool-proof portion and the plurality of metal contacts are arranged on a side edge of the circuit board, wherein the side edge faces the connection module.

7. The connector according to claim 5, wherein the signal terminal comprises a bent segment, and the bent segment has a protruding portion facing the metal contact.

8. The connector according to claim 7, wherein the plurality of signal terminals comprise a plurality of first terminals and a plurality of second terminals, and the bent segments of the first terminals and the bent segments of the second terminals have the same structure and opposite orientations to enclose an anti-crosstalk space between the plurality of signal terminals.

9. The connector according to claim 5, wherein the connection module further comprises a first shielding member, and the plurality of signal terminals are arranged on both sides of the first shielding member.

10. The connector according to claim 9, wherein the connection module further comprises a second shielding member and a third shielding member, wherein the second shielding member and the third shielding member are arranged on two outer sides of the plurality of signal terminals respectively.

11. The connector according to claim 10, wherein the shapes of the first shielding member, the second shielding member, and the third shielding member are matched with the shapes of the plurality of signal terminals.

12. The connector according to claim 1, wherein the connection module further comprises an insulating body, and a portion of the insulating body is configured as the second fool-proof portion.

13. The connector according to claim 2, wherein the connection module further comprises an insulating body, and a portion of the insulating body is configured as the second fool-proof portion.

14. The connector according to claim 3, wherein the connection module further comprises an insulating body, and a portion of the insulating body is configured as the second fool-proof portion.

15. The connector according to claim 4, wherein the connection module further comprises an insulating body, and a portion of the insulating body is configured as the second fool-proof portion.

16. The connector according to claim 2, wherein the circuit board is provided with a plurality of metal contacts, the connection module comprises a plurality of signal terminals, and the plurality of metal contacts correspond one to one with the plurality of signal terminals.

17. The connector according to claim 3, wherein the circuit board is provided with a plurality of metal contacts, the connection module comprises a plurality of signal terminals, and the plurality of metal contacts correspond one to one with the plurality of signal terminals.

18. The connector according to claim 4, wherein the circuit board is provided with a plurality of metal contacts, the connection module comprises a plurality of signal terminals, and the plurality of metal contacts correspond one to one with the plurality of signal terminals.

19. The connector according to claim 13, wherein the first fool-proof portion and the plurality of metal contacts are arranged on a side edge of the circuit board, wherein the side edge faces the connection module.

20. The connector according to claim 14, wherein the first fool-proof portion and the plurality of metal contacts are arranged on a side edge of the circuit board, wherein the side edge faces the connection module.
